(19) United States
(12) Patent Application Publication
(10) Pub. No.: US 2011/0060649 A1
(43) Pub. Date: Mar. 10, 2011

(54) SYSTEMS, METHODS AND APPARATUS FOR PROVIDING MEDIA CONTENT

(76) Inventors: Craig A. Dunk, Guelph (CA); Barry Gilhuly, Waterloo (CA); Shawn Kahandaliyanage, Kitchener (CA); David Kruis, Kitchener (CA); Emmanuel McCaull, Guelph (CA); Andrew Smith, Waterloo (CA); Tudor Whiteley, Waterloo (CA); Zhiguo Xu, Waterloo (CA)

(21) Appl. No.: 12/937,449

(22) PCT Filed: Apr. 14, 2009
(86) PCT No.: PCT/CA09/00445

§ 371 Date: Oct. 12, 2010

Related U.S. Application Data
(60) Provisional application No. 61/044,358, filed on Apr. 11, 2008.

(51) Int. Cl. G06F 17/30; G06Q 30/00; G06F 15/173

(52) U.S. Cl. 705/14.53; 707/749; 709/225; 707/E17.107

(57) ABSTRACT

A system for providing media content, including at least one media server, at least one database connected to the at least one media server, each database configured to store a plurality of media content, and at least one device configured for data communication with the at least one media server, each device associated with at least one user. Each media server is configured to determine a relevance between each particular media content and each particular user, and based on each relevance, determine whether to provide that particular media content to the device associated with that particular user.

### RELATED APPLICATIONS

This application claims priority to U.S. Provisional Patent Application Ser. No. 61/044,358, filed on Apr. 11, 2008, and entitled “SYSTEMS, METHODS AND APPARATUS FOR DELIVERING RELEVANT MEDIA CONTENT”, the entire contents of which are hereby incorporated by reference.

### TECHNICAL FIELD

The teachings disclosed herein relate to providing media content, and in particular to systems, methods and apparatus for categorizing media content and for delivering selected media content to one or more devices.

### INTRODUCTION

The availability of video clips and Internet sites that provide media content (e.g. video clips, audio clips, images, etc.) has exploded over the last few years. Some sites that host media content provide search tools where a user can enter a string of search text (e.g. one or more keywords) and request that the site provide matching media content. The site can then try to match the search text with tags that have been manually associated with the media content and return or display particular media content based on those matches.

The media content returned is frequently filled with noise, meaning media content that the visitors may not be interested in but which was returned because some of the tags associated with the media content matched the search text. Accordingly, desired media content that might be present in the results tends to get drowned out or lost in the noise.

In addition, there are many services that provide access to particular media content streamed through a browser on demand (e.g. based on channels or direct search). Such browser-based systems are primarily streaming-based, meaning that the media content requested by users is delivered upon request. This typically requires an active data connection with high bandwidth capabilities. For example, one suitable active data connection could be a high-speed cable Internet connection.

However, other data connections, such as wireless networks (e.g. 3G, EDGE, etc.) may have relatively limited bandwidth, high costs per quantity of data, and may suffer from intermittent coverage with frequent interruptions in data communication. This tends to ends to provide, at best, a choppy experience when streaming media content, and at worst, media content being completely inaccessible when connecting to streaming-based services.

Accordingly, the inventors have identified a need for systems, methods and apparatus that attempt to address at least some of these issues.

### SUMMARY

According to one aspect of the invention, there is provided system for providing media content, comprising at least one media server, at least one database connected to the at least one media server, each database configured to store a plurality of media content, and at least one device configured for data communication with the at least one media server, each device associated with at least one user, wherein each media server is configured to determine a relevance between each particular media content and each particular user, and based on each relevance, determine whether to provide that particular media content to the device associated with that particular user.

Each relevance may be determined by a relevance engine and may be based on metadata associated with the particular media content and the particular user.

The metadata may include at least one of previously expressed interests by that particular user for other media content, previously expressed interests of other users for other media content, previously expressed interests of other users for that particular media content, and keywords associated with that particular media content, keywords associated with that particular user, and a relevance between that particular media content and other media content.

The relevance may be based on at least one classification algorithm. The classification algorithm may include a Bayesian filter.

The previously expressed interests by that particular user may include ratings by that particular user of other media content indicative of that particular user's interest in a subject matter associated with the other media content.

The previously expressed interest by that particular user may include rankings by that user of the other media content indicative of that particular user's perception of the quality of the other media content.

The relevance engine may be configured to create at least one cluster of users based on similarities in the media content consumed by those users.

The relevance of particular media content to each user may be determined at least in part by the membership of that particular user in the at least one cluster and relevance of that particular media content to that cluster.

The media server may be further configured to determine whether to provide particular media content to the device based on a personalized content quantity determination that estimates a quantity of media consumption for that device.

The personalized content quantity determination may use an access profile associated with the device that contains information about the media content consumption behavior for that device.

At least one of the devices may be a mobile communication device configured to operate in a high bandwidth communication state and a reduced bandwidth communication state, and wherein the media server is configured to provide the particular media content to the device when the device is in high bandwidth communication state but not when the device is in a reduced bandwidth communication state.

In some embodiments, determining whether to provide particular media content to the device is at least partially based on an estimate of how often the device is in a reduced bandwidth communication state. The reduced bandwidth communication state can include a non-communication state.

The media server may be configured to communicate with at least one social networking application, and the media server may determine whether to provide particular media content to the device based on data associated with the social networking application. The at least one social networking application may include at least one of blogs, forums, websites, and other applications that permit community participation. The at least one social networking application may be a media content source website configured to permit visitors to receive user engagement (e.g. feedback) related to the media content provided on the website.

The media content may include advertising content. The advertising content may be interactive and may permit the user to execute transactions relating to the advertising content. In some embodiments, at least one transaction may initiated while the device is in a reduced bandwidth communication state, information required to complete the transaction is temporarily stored, and then the information is subsequently used to complete the transaction when the device is in a high bandwidth communication state.

In some embodiments, each relevance may be at least partially based on a prediction of a popularity of that particular media content.

According to another aspect of the invention, there is a method for providing media content, comprising, providing at least one media server, providing at least one database connected to the at least one media server, each database configured to store a plurality of media content, and providing at least one device configured for data communication with the at least one media server, each device associated with at least one user, determining a relevance between each particular media content and each particular user, and based on each relevance, determining whether to provide that particular media content to the device associated with that particular user.

According to yet another aspect of the invention, there is provided a physical computer readable medium including computer executable instructions which, when executed on a computing device, cause the computing device to determine a relevance between each particular media content of a plurality of media content and each particular user of a plurality of users, and based on each relevance, determining whether to provide that particular media content to a device associated with that particular user.

### BRIEF DESCRIPTION OF THE DRAWINGS

The drawings included herewith are for illustrating various examples of systems, methods, and apparatuses of the present specification and are not intended to limit the scope of what is taught in any way. In the drawings:

FIG. 1 is a schematic overview of a system for providing media content according to one embodiment;

FIG. 2 is another schematic overview of the system of FIG. 1;

FIG. 3 is another schematic overview of the system of FIG. 1;

FIG. 4 is a schematic overview of a media player according to one embodiment;

FIG. 5 is an illustration of a display screen of a media player according to one embodiment;

FIG. 6 is an illustration of a display screen of a media player according to one embodiment;

FIG. 7 is an illustration of a display screen of a media player according to one embodiment;

FIG. 8 is a graph illustrating the motion of a carousel on the display screen of FIG. 5 when released from somewhere other than one of the discrete positions;

FIG. 9 is a graph illustrating the motion of the carousel of FIG. 8 following the release of the carousel by a user; and

FIG. 10 is a graph illustrating results of a relevance engine according to one embodiment, where each keyword has been assigned a degree of ‘LIKED’ and ‘DISLIKED’, and the resulting values have been plotted on a graph.

### DETAILED DESCRIPTION

### Overview

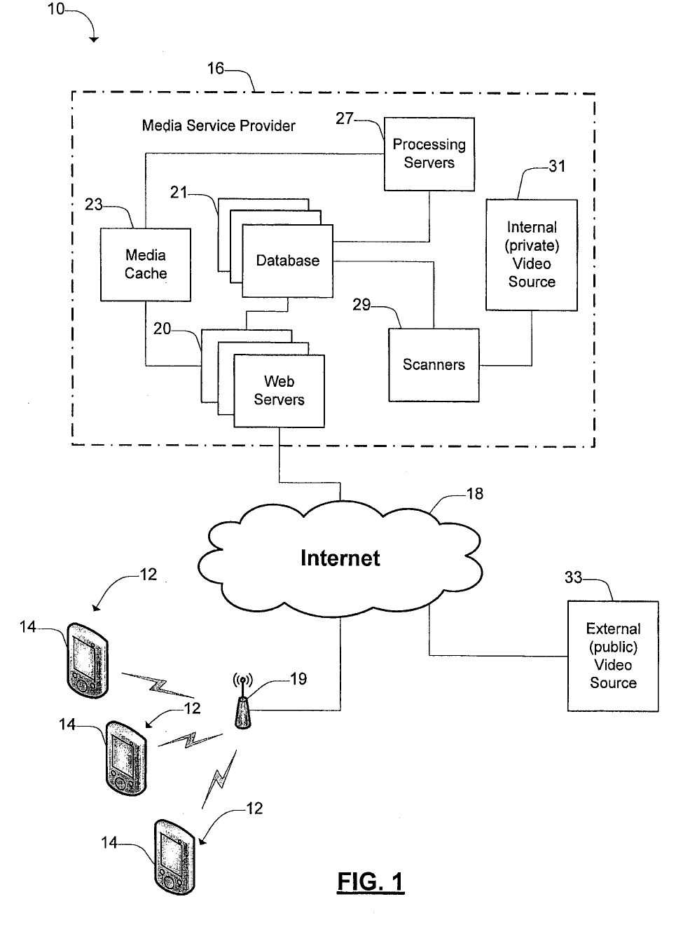

Turning now generally to FIGS. 1 to 3, illustrated therein is a system 10 for providing media content 25 according to one embodiment of the invention. The system 10 generally includes at least one media organizer or media player 12 (MP) software application that may be resident on, or accessed by, one or more devices 14. The system 10 also generally includes a media service provider 16 (MS) generally configured to provide media content 25 to the media player 12 on each device 14. The devices 14 may access the media service provider 16 through a data communications network, such as the Internet 18 or over a local area network (LAN) 35.

As shown, the media service provider 16 generally includes one or more interconnected media servers 20 configured to provide the media content 25 to the devices 14, and one or more databases 21 connected to the media servers 20 that store the media content 25. In some embodiments, the media service provider 16 may include a media cache 23 for temporarily storing or caching media content 25 to be sent to the media servers 20, and/or one or more processing servers 27 for facilitating access to the media content 25 in the databases 21. The media servers 20 may also directly access the media content 25 in the databases 21 without using the processing servers 27.

The media service provide 16 may be configured to receive media content 25 from an external or public video source 33, for example from a website such as YouTube. Furthermore, one or more internal or private video sources 31 may also be inspected or mined for media content 25 using one or more scanners 29.

As will be described in greater detail below, the media service provider 16 may index the available media content 25 stored in the databases 21 and then select particular media content to be provided to particular devices 14 based on a relevance as determined for particular users. For example, the media service provider 16 may be configured to collect subscriber information (e.g. statistics about the viewing habits of each user or a group of users) for use in determining the relevance between particular media content and particular users.

As shown, in some embodiments, the media servers 20 may include one or more web servers configured host one or more web pages. The web pages may allow subscribers to setup an account, and in some cases establish a profile. In some embodiments, this setup may include the subscriber selecting specific likes and dislikes from one or more predetermined lists of subject matters or topics (e.g. sports, music videos, politics, cooking, etc.). For example, the user may indicate that they have a high interest in sports and cooking but a low interest in politics.

In some cases the user may be able to enter additional keywords to express user interests (e.g. likes or dislikes) that may not provided be as predetermined topics. For example, a particular user may be able to manually enter keywords to indicate that they like specific subjects (e.g. orange cats) but dislike other subjects (e.g. brown dogs) even when such categories or topics have not been predefined.

Generally, once an account has been created, that subscriber can communicate with the media service provider 16 using a particular device 14 to access or download media content 25.

In other embodiments, the device 14 may be able to connect to the media service provider 16 without an account being used (e.g. anonymously). In some cases, such anonymous connections may be managed by using a unique identifier associated with each particular device to track the consumption of media content 25 on that device (which can be a permanent identifier or a temporary identifier).

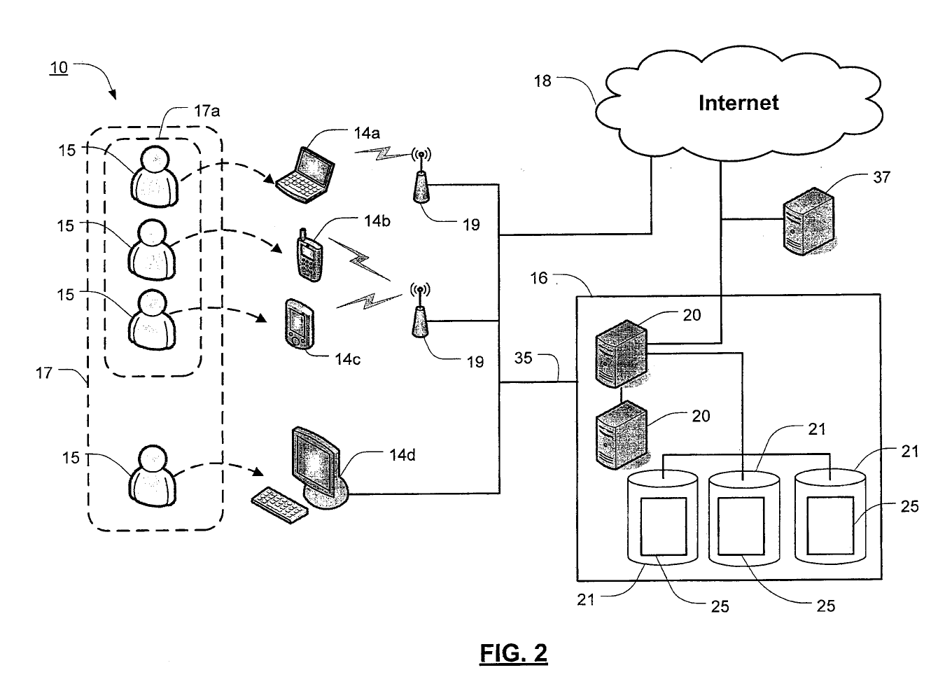

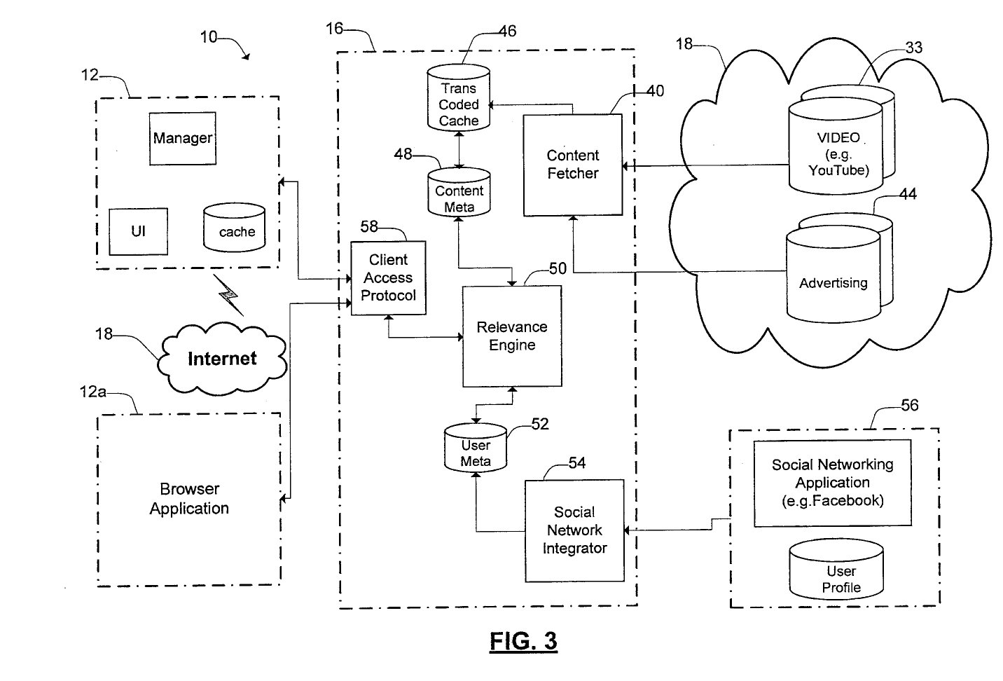

The device 14 may generally be any suitable computing device. In some embodiments, the device 14 may a mobile device (e.g. a smart phone or PDA) capable of wireless communication via a wireless access point 19. For example, as shown in FIG. 2, the devices 14 could include laptop or netbook computers 14a, smart phones 14b, PDAs 14c, desktop computers 14d, and generally any other wireless or wired communications device that may have the media player 12 installed thereon, or which may be configured to access the media player 12 (e.g. through a browser over a data connection). In particular, the media player 12 could be loaded via a web browser application 12a (as shown in FIG. 3) as opposed to a client application that is installed on the device 14.

As shown in FIG. 2, each device 14 is typically associated with one or more users 15. In some cases, the users 15 may be considered to be part of one or more groups or clusters. For example, as shown a first group or cluster 17 includes four users 15, while another group 17a includes three users 15.

In some cases, the groups 17, 17a may be defined based on certain predefined characteristics (e.g. a geographic location of the users 15, their ages, etc.). Groups 17, 17a may also be defined based on manual input, such as the preferences of the users 15 (e.g. group 17 may include all users who like sports 15, while group 17a may include those users 15 who also like baseball).

In some embodiments, some groups 17, 17a or clusters may be defined by the media service provider 16 and may be based on historical or statistical information about the users 15. For example, the group 17 may include the users 15 who regularly watch similar types of videos. Thus, the media service provider 16 can attempt to create groups or clusters of users with similar patterns of expressed user interests (e.g. likes and dislikes). This may be useful when trying to select particular media content that particular users will like (e.g. if all the users in a cluster usually like the same media content, then it is more likely that one particular user in that cluster will like a particular media content if all or a majority of the others users in that cluster like that particular media content).

In some cases, the groups 17, 17a may be based on authorization criteria. For example, group 17 may include users 15 and generally represent public users with free access to the media service provider 16, while group 17a may be users 15 who have a paid subscription to use the media service provider 16.

In some cases, the various users 15 within different groups may have permission to view different media content 25. For example, users in group 17a with a paid subscription may be able to access all media content 25 provided by the media service provider 16, while users not in group 17a may only be allowed to access limited content (or may be required to pay a usage fee each time they want to access “premium” content that is freely available to the users in group 17a).

As shown in FIG. 2, the system 10 may also include one or more backup servers 37, which may duplicate some or all of the media content 25 stored on the databases 21. The backup servers 37 may be used for disaster recovery purposes to prevent data loss in the event of a fire, flooding, virus, etc.

In some embodiments, the backup servers 37 may be directly connected to the media service provider 16 but located within the system 10 at a different physical location. For example, the backup servers 37 could be located at a remote storage location at a distance from the media service provider 16, and the media service provider 16 could connect to the backup server 37 using a secure communications protocol.

Turning now to FIG. 3, as shown the media service provider 16 may include a content fetcher 40 configured to retrieve media content 25. For example, the content fetcher 40 may be configured to retrieve external public videos 33 (e.g. from YouTube and other similar sources) and/or internal or private content 31. The content fetcher 40 may also be configured to receive media content 25 where that media content 25 is or includes advertising content 44. For example, advertising content 44 could include banner information (e.g. which may be displayed in association with other media content 25 when played by the media player 12), advertising videos (e.g. commercials, etc.), and/or generally any other advertising content.

In some embodiments, the media service provider 16 may also transcode the media content 25 into a supported data format (e.g. from an AVI video format into a MPEG format) so that the media content 25 can be played back by the media player 12. The media service provider 16 may store the transcoded media content 46 (at least temporarily) in a cache 46 to further facilitate the transcoding.

As shown, the media service provider 16 may also include a content metadata database 48. The content metadata database 48 can store content metadata associated with particular media content 25. The content metadata can include predefined data (e.g. keywords manually associated therewith), data that may be automatically captured (e.g. the date and/or time that the particular data was retrieved by the content fetcher 40), and dynamically generated information, such as the relevance or similarity between particular media content (e.g. whether two media content objects have similar like or dislike patterns, and perhaps should be grouped or clustered together).

In some embodiments, the dynamic generation of content metadata information may be performed by one or more relevance engines 50. Each relevance engine 50 is generally configure to analyze the media content 25 and the users 15, determine a relevance between each particular media content and each particular user, and, based on the relevance, decide whether to provide that particular media content to that particular user.

In some embodiments, the relevance engine 50 may generate unique identifiers to use as keywords or tags in association with particular content. For example, the relevance engine 50 may assign groups or clusters of media content with similar like or dislike patterns with an alphanumeric identifier, such as “A3F451G4”.

The unique identifiers operate as artificial or “fake” tags that allow relationships between various media content 25 to be more easily defined and managed. For example, new media content can be later added to a cluster by associating the corresponding “fake” tag (e.g. “A3F451G4”) with the new media content.

As shown, the relevance engine 50 may also be coupled to a user metadata database 52 that stores the user metadata associated with each particular user. Similar to the content metadata, the user metadata may be predefined (e.g. keywords associated with the users or preferences indicated by the users), automatically captured (e.g. the age of the each user, their gender, etc.), and/or dynamically generated (e.g. by the relevance engine 50 based on behaviors or statistical patterns associated with the users, such as expressed user interests). In some embodiments, unique identifiers or “fake” tags may be used to define clusters or groups of users and this information is then stored in the user metadata database 52.

In some embodiments, the media service provider 16 may include a social network integrator 54 configured to communicate with one or more social networking applications 56 (e.g. Facebook, MySpace, LinkedIn). The social network integrator 54 may retrieve information from the social networking information 56 (e.g. user profile information, friend information, expressed likes and dislikes within that social networking application 56, etc.) and may use this information to generate additional user metadata.

The media service provider 16 may also include a client access protocol module 58 to facilitate communication between the media service provider 16 and the media players 12, 12a).

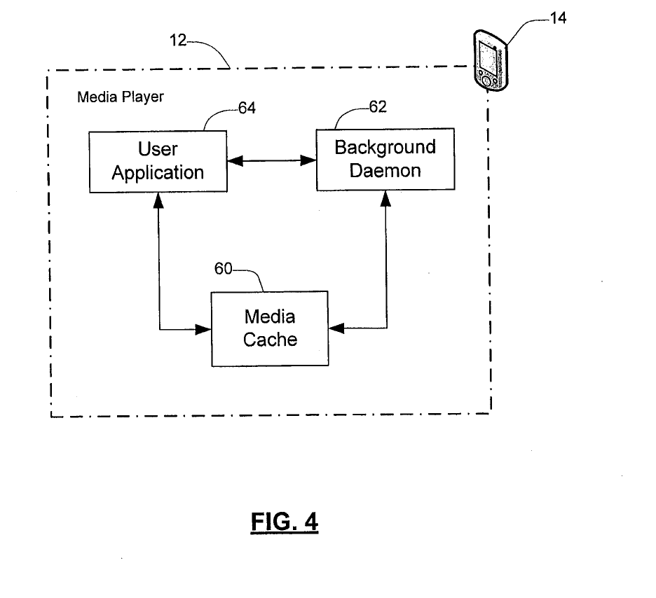

Turning now to FIG. 4, one embodiment of the media player 12 is shown in additional detail. The media player 12 may include a media cache 60 for temporarily storing or caching downloaded media content 25, and a user application module 64 configured for organizing and displaying media content 25 (e.g. by playing the media content using on one or more output modules, such as a display screen and speakers, etc.).

The media player 12 may also include a background daemon 62 configured to operate in the background. The daemon 62 may monitor the state of the device 14 on which the media player 12 is running (e.g. is the device 14 in a high bandwidth communication state or a reduced bandwidth communication state, etc.) and may trigger corresponding changes in the behavior of the device 14.

The media player 12 is generally configured to collect subscriber usage information indicative of user interests (e.g. statistics about patterns of user behavior, such as which videos were liked or disliked, how many times a particular video was watched, was the video watched completely, was this video flagged as a favorite or saved, etc.) and communicate that usage information back to the media service provider 16.

According to some embodiments, the media player 12 may present some or all of the downloaded media content 25 on a carousel shown on the display screen of the device 14. The carousel may respond to user input, for example the carousel may be capable of being manipulated by the user through a touch interface, as will be described in greater detail below.

### The Carousel

Visual

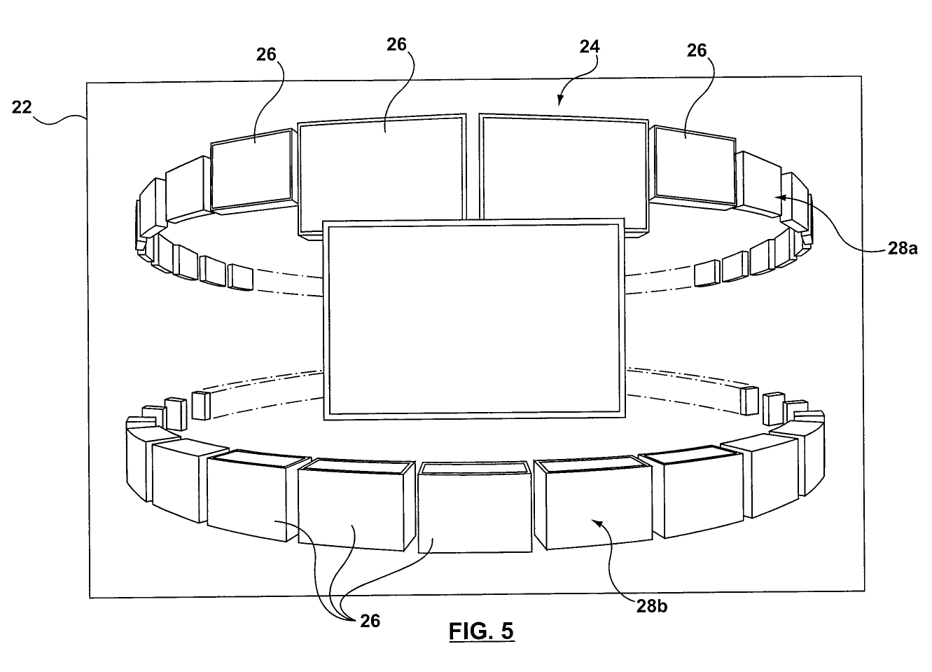

As shown in FIG. 5, in some embodiments each user device 14 may include a display screen 22 that shows a carousel 24 thereon. Generally, the carousel 24 may be used for manipulating media content on the device 14.

For example, items 26 on the carousel 24 may be laid out in one or more generally three-dimensional rings (shown here as two rings 28a, 28b). The user of the carousel 24 may be able to interact with either ring 28a, 28b independently to manipulate digital items 26 and to otherwise control the media player 12 on the device.

In some embodiments, the digital items 26 may be visual representations of one or more media content 25 items. For example, if a particular media content 25 is a picture, then the digital item 26 relating to that particular media content 25 could be a thumbnail view of the picture.

In another example, if the media content is a video file, the digital item 26 relating to the media content could be one of more frames from the video file, which could play in a loop (also known as a “video thumbnail”).

In yet another example, if the media content 25 is a music file, the digital item 26 relating to the media content could be an image of the album cover associated with that song, or an image of the artist(s) associated with that particular music file.

In some cases, the digital items 26 may be generated by the media player 12 using the media content 25. In other cases, the digital items 26 may be generated by the media service provider 16 from the media content 25, and may be provided to the media player 12 along with the media content 25.

In some cases, each ring 28 may represent one or more levels of organizational structure present within the media player 12. For example, one ring (e.g. the bottom ring 28a) may represent the containers found on the root of the system, while the second ring (e.g. the top ring 28a) may represent files found within whichever container is currently active within the top ring 28a.

In some embodiments, the visual elements of the carousel 24 may be displayed using a lightweight 3D rendering engine that is able to render the digital items 26 from triangle meshes and display them with dynamic lighting and reflections on the display screen 22.

Position

In some embodiments, the digital items 26 may be ordered within the rings 28 of the carousel 24 according to various different configurations. For example, the digital items 26 may be ordered by the arrival date of each digital item 26 on the device 14. As new digital items 26 arrive on the device 14, they may be placed at the beginning of the list or ring 28. In other examples, the digital items 26 may be ordered or sorted by the types of media content 25 that are represented (e.g. video clips, still pictures, etc.), by categories (e.g. sports, politics, arts, etc.), and/or other criteria such as size or popularity.

In some embodiments, digital items 26 may generally rest in one or more discrete positions in the rings 28. When an item 26 is released and/or held in a position other than one of these discrete positions and then released, the item 26 may then move or “settle” into the closest or another nearby discrete position.

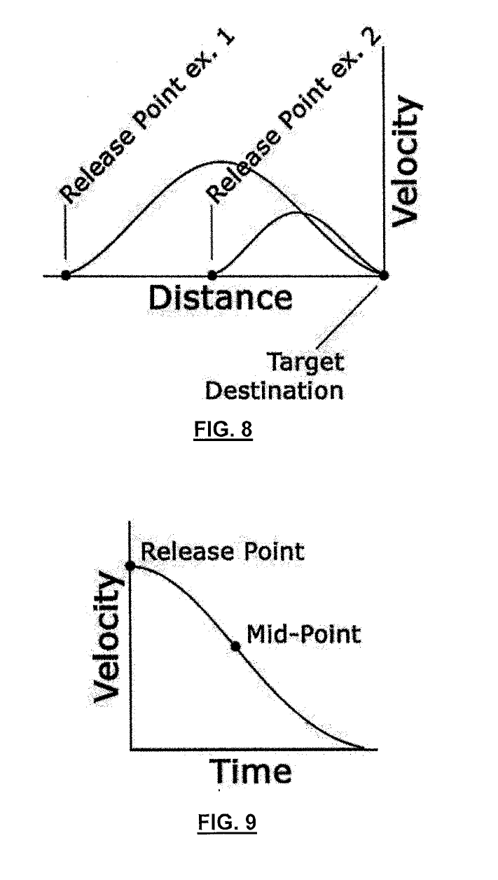

This motion is described visually by the graph shown in FIG. 8. For example, the media player 12 may calculate the distance between the current position of a digital item 26 and its target destination, as well as the midpoint between the current position and the target destination. The item 26 then accelerates towards the midpoint. The velocity at which the item 26 is traveling when the item 26 reaches the midpoint may be determined by the distance between the release point of the item 26 and the target destination.

Once the item 26 reaches the midpoint, it starts to decelerate. The graph in FIG. 8 shows two examples of a release points with the same target destination, showing that different velocity profiles may be adopted by each item 26 to achieve the same desired destination.

Interaction

In some embodiments, there may be two levels or types of selection gestures that are available within the carousel 24. For example, one is a general selection that may be described as a single tap selection, while a second general selection may be described as a double tap selection. The actions that are triggered by each of these two selections may be as described below.

Single Tap

In some embodiments, a single tap may bring a digital item 26 into focus, and may bring it to the closest point or discrete position to the user for closer inspection. In some cases, if the digital item 26 is already in focus, then a single tap may activate the digital item 26.

Activating a digital item 26 may cause an action to be performed, where the action corresponds to the type of media content that the item represents. For example, if the item 26 represents media content 25 that is a video clip, then a single tap may activate the digital item 26 by launching a video player application and playing the video clip within the video player application.

In another example, if the digital item 26 represents a music file, then a single tap may activate the digital item 26 by launching a music player application and playing the music file within the music player application. In some embodiments, a single application may be able to playback various types of media content 25 (e.g. the video player application may also be capable of playing music).

In some embodiments, if the display screen 22 and/or the digital item 26 is pressed in a specified area, the single tap may provide the user with additional information about that digital item 26 (e.g. metadata), information about the media player 12, and so on.

Double Tap

In some embodiments, a double tap may be used to perform other actions. For example, a double tap may bring a digital item 26 to the foreground and activate the digital item 26 with one action (i.e. a double tap may automatically launch the video player and immediately play the item 26.)

Hold/Press

In some embodiments, if a user presses and/or holds the digital item 26, that item 26 may be detached from the carousel 24 and enabled to move and be placed within another container or discrete location within a ring 28. For example, the user may “drag and drop” the item 26 into another container, or rearrange the order of the digital items 26 placed in a ring of the carousel 24.

Motion

In some embodiments, the rotational speed of the carousel 24 and/or a digital item 26 within the carousel 24 may be based on the speed of the input device (e.g. a user's finger) upon release of the digital item 26. For example, the graph in FIG. 9 represents the motion of an item 26 when it is released while in motion.

In some cases, the initial velocity may be determined by the speed of the input device moving across the display screen 22. Once the user releases the input device (e.g. by removing their finger from the display screen 22), the velocity of the digital item 26 starts to decay by decelerating over a preset period of time. Once the digital item 26 reaches the mid point in that preset period of time, then its deceleration slowly starts to decrease so that the digital item 26 settles into a desired rest position.

The input device may vary according to the type of device 14 associated with the media player 12. For example, if the device 14 has touch-screen input capabilities, the input device may be a user's finger or a stylus. In other embodiments, the input device may be one or more buttons, a pointing device (e.g. a mouse or trackball), a keyboard, and/or any other type of input that the device may be configured to support.

In some embodiments, the motion of objects or digital items 26 may be handled by an animation sub-system. The animation sub-system may be able to perform smooth animations by taking a small number of frames of animation and interpolating between frames to generate in-between frames.

In some cases, the speed of each animation can be varied dynamically through the use of a transition function. This function may allow for the ability to move through the animation at a rate that differs from animation start to animation end, providing the illusion of acceleration and object momentum.

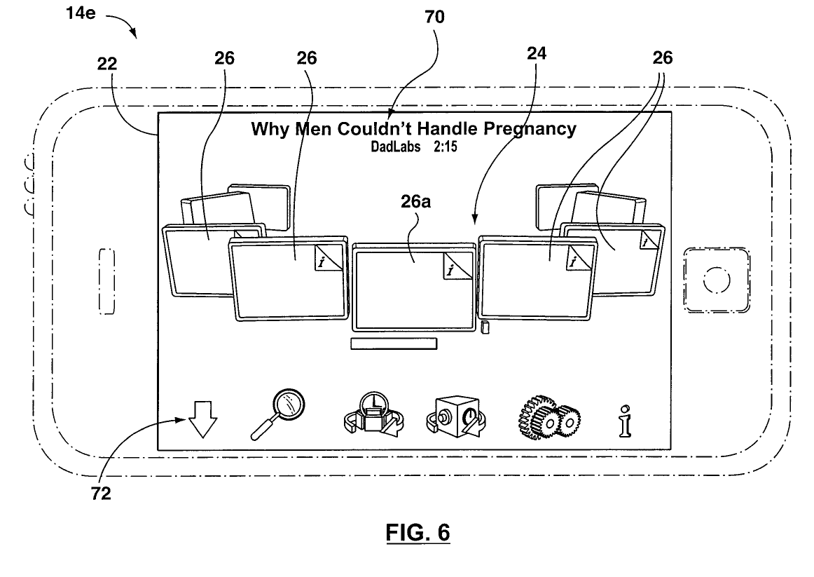

Turning now to FIG. 6, illustrated therein is a device 14e having a display screen 22a according to another embodiment. In this embodiment, the digital items 26 are laid out in a carousel 24 having one ring 28, with each digital item 26 representing a particular media content 25. As shown, the display screen 22 may also present content information 70 (such as the title of the currently active digital item 26a, here “Why Men Couldn't Handle Pregnancy”, the content creator “DadLabs” for that particular digital item 26, and a runtime, in this case 2:15).

The display screen 22a can also present a tool bar 72 which can allow the user of that device 14e to take specific action (e.g. save a particular media content, search, watch a tutorial, change settings, etc.)

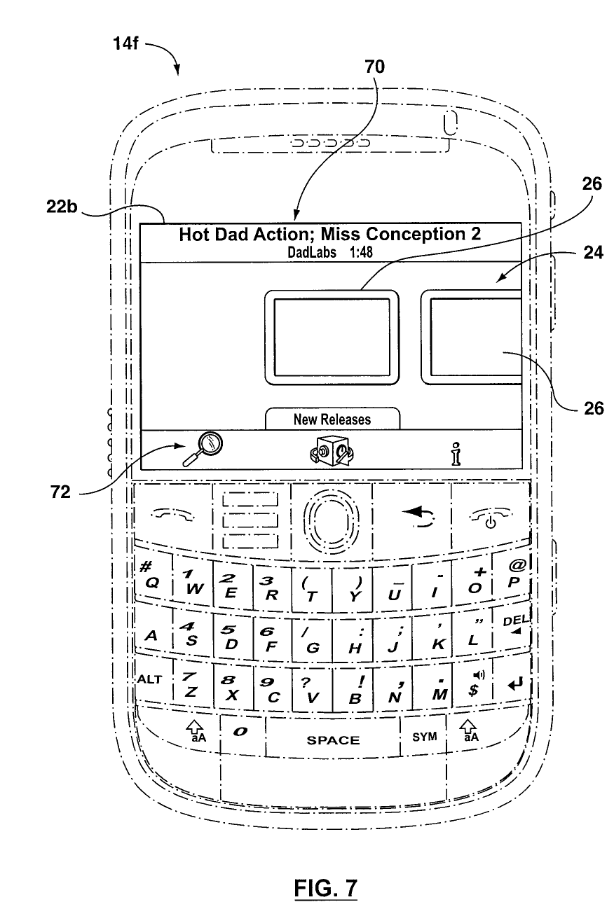

Turning now to FIG. 7, illustrated therein is a device 14f according to another embodiment with another display screen 22b. In this embodiment, due to the size of the display screen 22b, the carousel 24 appears fairly linear. This display screen 22b also shows content information 70 as well as a toolbar 72.

### Virtual Window Tutorial Interactive Video

In some embodiments, the media player 12 may include a video tutorial that may help to introduce the media player 12 and/or media service providers 16 to one or more subscribers or users 15. The video may generally be fully interactive, allowing subscribers to choose their own path through the material.

The video tutorial may include a host. The host of the video may speak to the subscriber directly, as if speaking through a window comprising the display screen 22. The dialogue of the host may be directed at or to the subscriber or user, instructing them to perform specific actions, and then waiting for the subscriber to act.

These instructions may be provided in the form of a video, for example, where it appears that a video personality or host is actually manipulating the display screen 22 from the opposite side of the display screen 22. A real world analogy would be a first person standing on one side of a glass door, with a second person standing on the other side of the glass door. The first person can show the second person how to open the glass door by pushing the door in a certain direction (e.g. by pushing on the glass door towards the second user). The second user will then understand that they must pull the glass door towards them in order to open the door.

In some cases, the program can generally respond to each user's input and adjusts the instructions being presented appropriately.

In some embodiments, the program may track and store the different user interactions with the device 14. If the user performs a particular task correctly, then the tutorial may move forward to the next stage. Conversely, if the user does not perform the task appropriately, then the instruction may be repeated as the same video or in the form of a second video with one or more additional visual cues.

In some embodiments, visual cues may be used to supplement the video tutorial. A first cue may be the use of a semi-transparent screen overlay (e.g. a green translucent stripe or other suitable overlay) that indicates the desired motion of the user's finger or other input device and which tracks the video personality or host's finger relative to the display screen 22 on the device 14.

A second cue may be the use of a second semi-transparent overlay (e.g. a blue translucent stripe, or a suitable overlay different from the first cue) dynamically created by the user's last interaction with the device. Given that the user may not have performed the particular task correctly, the second cue may be used to indicate the undesired path that was taken by the user. This sequence may be repeated until the user correctly performs the task or chooses to exit from the tutorial.

As described, the tutorial is conceived of being specific to a touch-based device 14 (for example a smart phone capable of receiving user input directly through a touch sensitive screen). The same concepts may be equally applicable to desktop training applications or tutorials configured for other devices 14.

### Personalized Content Quantity

According to some embodiments, an automatic content selection technique may be used for a media content transfer system that has periodic high-bandwidth connection to a data source. For example, a device may only be in high-bandwidth communications state to the data source through a wireless network with intermittent network coverage, such as IEE 802.11 standard WiFi networks which may be encountered only a few times in the course of a particular day.

In such systems, one goal may be to have adequate quantities of information or media content 25 for an end user to consume during a predetermined period, but to avoid providing excess media content 25 which may have a negative effect on battery life. Furthermore, excess content may further degrade the quality of the information made available to the user, assuming that the most desirable content may be delivered first. In particular, it is generally desirable that less media content 25 of a higher interest level to a particular use be provided to the device 14, as opposed to more media content 25 that isn't as interesting to that user.

In order to increase the quantity of desirable content available to the user on a particular device when the device 14 is in a reduced bandwidth communication state (e.g. where the data connection is slower and/or in a completely non-communication state, such as when the antenna and/or transceiver is off-line or the device 14 is located out of a data coverage area), a content quantity selection system (CQSS) may be used to evaluate one or more sets of data. For example, the CQSS may evaluate historical data related to the quantity of user's content consumption in association with a particular device 14.

This historical consumption data may use factors including, but not limited to: time spent viewing the media content, percentage of media content or other items that were ignored, and time spent repeatedly accessing particular media content. Furthermore, this consumption data may be tracked as a function of location, time of day, and/or day of week, or other suitable variables.

A second piece of data tracked by the CQSS may be related to an access profile for the device 14. This access profile may record the number of times and amount of time the device is in high-bandwidth data communication state with the media service provider 16 by attempting to contact the media service provider 16 both periodically and/or when platform subsystems indicate that data coverage changes (e.g. the device 14 moves into or out of a WiFi hotspot). Upon confirming data coverage, the media player 12 may record the amount of time spent in a reduced bandwidth communication state to be used to calculate the amount of content required for use when the device 14 is in such a state (e.g. out of coverage).

By combining a historical record of consumption with the data coverage profile, a measure of the amount of needed or desired media content 25 can be established. In one embodiment, this measure can represent the average amount of media content 25 required per unit time multiplied by the average time spent with the device being out of coverage.

A specific example of an alternative embodiment may be to employ statistical methods such as utilizing standard deviation calculation to achieve improved confidence that the user will not be without content. For example, the media service provider 16 could be configured to ensure that enough media content is present on the device 14 to occupy the users typical behavior at a 95th percentile scenario.

### Relevance

According to some embodiments, relevance of particular media content 25 to particular users 15 may be determined by scoring individual media content items using one or more of relevance engines (e.g. relevance engine 50). In some embodiments, each relevance engine 50 could be a specific instance of a more general relevance engine 50.

Each relevance engine may be capable of selecting different criteria to determine whether particular media content 25 is suitable for a particular subscriber or user 15. Each relevance engine 50 may be capable reducing or reinforcing the scores of other relevance engines 50. The final result may be a relevance score that represents a cumulative response to the rating engines.

Each engine may use one or more classification algorithms to determine the suitability of particular media content 25, and which may include the use of a probability filter. For example, one relevance engine 50 may use a Bayesian algorithm that uses keywords extracted from the subscriber's activity, and uses the keywords to filter the available media according to the following formula:

$$P ( Interest / Words ) = \frac{( P ( Words / Interest ) * P ( Words ) )}{( P ( Interest ) )}$$

where:
P(Interest|Words) is the probability that the subscriber will be interested in the media, given the associated words;
P(Words|Interest) is the probability a given set of words are an indication of interest given previous user responses;
P(Words) is the probability of the words appearing;
P(Interest) is the probability that any media could be interesting.

Similar calculations may be performed for disinterest or dislikes, and the resulting pair of probabilities may be combined to give a resulting relevance score.

Experimentation has shown that while a Bayesian engine may be good at classifying and categorizing media, it doesn't automatically give a good indication of the relative quality (e.g. the degree of “goodness” or “badness”) of that classification. Accordingly, the probability algorithm can be tuned to give better results.

One tuning mechanism is to use the ratio of the average value (either good or bad) of rated media content (by the subscriber) to the calculated value of the individual tags. For instance, if the subscriber is currently rating 30% of media content 25 as spam, and a tag's has been calculated as 20% spam (less than the average), the tag's adjusted probability may be calculated as:

$${P ( x )}_{adj} = \frac{( P ( x ) )}{( {P}_{overall} )} = ( \frac{.2}{.3} ) = .166 \{ \dot{6}$$

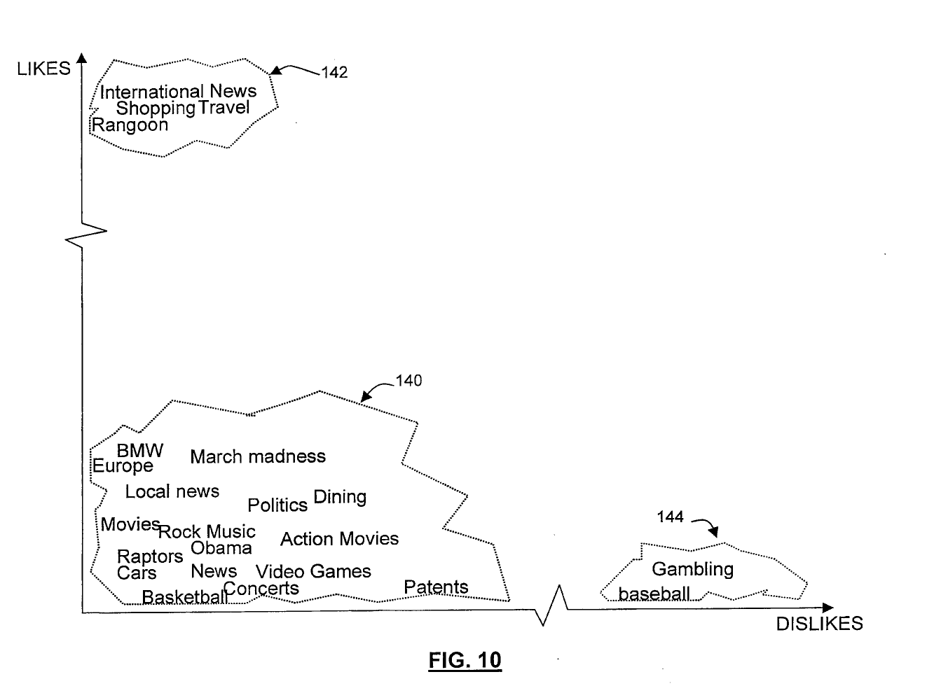

decreasing the significance of the result. A graphed example of the resulting values according to one embodiment can be found in FIG. 10. As shown, for this example many tags 140 are distributed near the origin of the graph, while strongly liked tags 142 are grouped near the end of the LIKES axis, and strongly disliked tags 144 are grouped near the end of the DISLIKES axis.

As the subscriber continues to grade viewed content on a particular device 14, metadata (e.g. tags) associated with the media content 25 and/or the users 15 may be included in the information that determines the probabilities of a keyword being either liked or disliked. As a result, a Bayesian engine or media filter may be able to learn, not only what particular media content 25 the subscriber wants to see, but also any media content 25 that should be excluded from the subscriber's queue.

According to some embodiments, the media service provider 16 can separate the grading of media into two distinct forms: “rating” and “ranking”. Generally, rating media tells the media service provider 16 which types of media a particular subscriber likes (e.g. what subjects or topics). The collected rating statistics may then be used to select future media for delivery to the subscriber on the device 14.

On the other hand, ranking media may generally tell media service provider 16 what the user's 15 perceived quality of the media content 25 is, such as which media content 25 is a good (or bad) example of the type of media content 25 that the subscriber likes. As an example, a subscriber who likes animal stories, might “rate” a video of cats as highly desirable because they want to see more cats. At the same time, they might not like the production values of that particular video and so they may “rank” that video poorly (and may, at their discretion, let their friends know that the video isn't worth watching). In other words, “rating” tends to describe the types or categories of media content 25 that the particular user 15 likes, while “ranking” tends to describe the quality of the particular media content 25.

In some embodiments, the media service provider 16 may apply a parallel relevance engine 50 that evaluates tags based on their cumulative relative worth. Tags that are attached to media content 25 that is consistently scored highly over time may become a strong positive indicator of important media content. For example, tag values may be summed, meaning that subsequent negative rankings can reduce or eliminate the positive value of tags.

In order to expand discovery, the media service provider 16 may use rating information taken from the subscriber's peers in a particular social network (e.g. Facebook) and may use that information to find secondary relevance for particular media content 25 and users. For example, the ratings and/or rankings of one or more friends of a particular user and other related feedback may positively or negatively affect the media content that is delivered to a subscriber's device 14.

In some embodiments, the social networking application might include websites that permit community involvement. For example, some websites permit users to provide feedback on particular media content 25. User feedback on some of the websites may be used by media service provider 16 to determine whether to provide the related media content to media player 12.

In some embodiments, the media service provider 16 may monitor the feedback on these websites or other locations and may determine that particular websites or other locations are likely to operate as “indicator sites”. In particular, certain behaviors on such indicator sites may be used to make predictions about the subsequent popularity of particular media content 25, which in some cases may be used to increase the relevance of that media content 25.

For example, when particular media content 25 appears on certain websites, in some cases with a very high rating or with a certain amount of user engagement (e.g. positive and/or negative comments, links sent to other users, etc.) this may be a good indication that the particular media content 25 is likely to become “viral”, meaning incredibly popular and widely seen (e.g. whether a particular song or video is going to be a “hit”). It may be desirable to identify such “viral” media content 25 as early as possible so that such media content 25 can be provided to users 15 in a timely manner.

It may be possible to add further relevance engines to the system, for example engines that may take advantage of other known characteristics of the subscriber's behaviour. For example, one such relevance engine might select media content 25 for a subscriber based on the opinions of all (or a large number) of subscribers on a particular website (crowd sourced popularity).

Another relevance engine (e.g. a synchronicity engine) could select media based on the similarity of previous choices: if the opinions of user X have a high degree of similarity to user Y, and user X subsequently likes a particular media item, then a synchronicity engine would score that media highly for user Y as well.

A further extension of this may be to use subscriber activity to create “clusters”, and from each cluster, define one or more pseudo profile. One possible mechanism is to take a subscriber's tag values and compare them with other subscribers. Subscriber's with similar values (within a margin of error) could be judged the same, and possibly identified as members of a group (e.g. groups 17, 17a). For example, if a number of subscribers sign up that like to watch hockey videos, the system automatically detects their similarity and could create a profile that could be used in place of them: the hockey viewer.

The engines may then use pseudo profiles that are associated with that group or cluster to score incoming media content 25 instead of the individual subscribers tag sets as an optimization (e.g. determining whether to provide particular media content to particular users on the basis of the profile of a cluster of users 15).

New subscribers who join the system 10 may also be able to choose from existing pseudo profiles as a mechanism to establish initial tastes early and minimize training time. For example, a user who is new to the system could be presented with a list of pseudo profiles, and related media content 25, and be given the opportunity to join one or more clusters. Then, as that user begins to rank media content 25, their profile may change dynamically to reflect their actual activity or behaviors (e.g. some cases, they may even be removed from the group that they explicitly joined).

Scoring information can be drawn from explicit ranking by subscribers, ranking by their friends, subscriber/device activity (repeated viewings, incomplete viewings, deletion of media content without viewing, ignored media content, viewing order, etc.), and other behaviours. For example, if a subscriber repeatedly view a particular media content, media content similar to that particular media content may be considered to be more desirable for that subscriber.

On the contrary, if a subscriber ignores certain media content (by not activating) and/or deletes certain media content without viewing, then similar media content may be withheld from that subscriber in the future. Repeated actions, such as repeated viewing or ignoring of media content may be a factor to determine whether to provide similar media content to the subscriber.

Use of a Bayesian engine or other engine for determining relevance is not restricted to mobile access. Other possible embodiments include a browser based video service that selects media on the subscriber's behalf and presents those selections through a web page, for example, which may be loaded on a desktop computer or a laptop.

### Automatic Classification of Content

In some embodiments, the media service provider 16 may be capable of learning from the subscriber's feedback how media content 25 should be grouped. When a subscriber classifies media content 25 on their device 14, the resulting association between the keywords associated with the media content and the category may be communicated back to the media service provider 16 (for example, when the device 14 returns to an in-data or high bandwidth communication state after being in a reduced bandwidth or non-connected communication state).

The media service provider 16 may use one or more classification engines to build one or more predictive models for how new media content 25 should be classified. When new media content 25 arrives, it may be compared against the predictive models and the suggested category, and may be sent to the device 14.

In some embodiments, with additional category information, the device 14 may be able to pre-sort the media content 25, allowing for a better user experience, either in maintaining the media content 25 on the device 14, or in simply enabling the subscriber to find certain types of media content 25 first or more quickly.

In some embodiments, the media player 12 may manage some categories automatically, and may creating new categories when the subscriber decides on a new grouping. Automatic categories may be assigned one or more colours, icons, text identifiers (e.g. the subscriber may choose the labels from a stock list or make up their own), or some combination of all three.

One possible implementation is to have an empty ‘box’ on the screen that the subscriber can drop digital items 26 into. Categories may also be explicit, for example categories may be created when the subscriber requests that a new group be created.

This automatic classification has other possibilities. As models are built, they could be used to add new semantic-based tags to the media content 25, allowing for an expanded set of keywords that better describe the media content 25. Automatic classification may also contribute to the process of grouping like subscribers into clusters or groups.

Classification information may be shared across the subscriber base. If multiple subscribers tend to group the same content in the same way, then they have similarities that may be usable in determining the suitability of particular content media content 25. For instance, the media service provider 16 could add additional tags to media content 25 based on the tags already in a grouping. The more subscribers that have the same or similar groupings, the stronger the likelihood that keywords drawn from that group are applicable to all media content 25 objects or items in that group.

In addition to automatic classification, subscribers may also have the ability to view, add, remove and adjust the tags associated with media content 25. This allows the subscriber base to improve the accuracy and/or validity of the tags assigned to media content 25.

In some embodiments, subscribers that frequently create and/or share reviews of media content 25 may be identified in the system 10 as potential candidates for early media reviews or for preferred access. These subscribers may be sent specific videos with the goal of having them share their opinions (either good or bad) with their social network and/or the general public.

In some embodiments, a subscriber's social effectiveness could be evaluated based on their sharing record and possibly their ability to influence friends and others to view particular media content 25. This social ranking may contribute to the decision as to which subscribers get early access or other possible reward programs.

### Discovery

One potential limitation to automatically selecting media based on subscriber responses is the potential of a particular subscriber becoming ‘pigeon holed’, where that subscriber continues to receive only similar media content 25 without significant variety. The media content 25 that is delivered to the device 14 may be desired media content 25, but it may only reflect the limited interests that the subscriber has expressed so far.

One goal of the system 10 may be to keep the subscribers interested, for example by selecting items that the subscriber is unlikely to have seen before, but may find interesting (either because other subscribers liked them, or they are tagged with top keywords, are “viral”, or simply because they've never seen or commented on anything with that particular set of keywords before).

Accordingly, the media service provider 16 may occasionally check the queue of media content 25 being sent to the device 14 and randomly insert other media content 25 (e.g. media content 25 that the relevance engines 50 may have rated as generally neutral, neither particularly desirable or undesirable). By randomly inserting these items, the subscriber may have the opportunity to respond and/or react to a set of keywords they haven't previously been exposed to, possibly expanding the available media content that the media service provider 16 then knows that the particular subscriber is interested in.

In some embodiments, the inserted media content 25 could be one of a number of selected media content 25 with specially constructed associated keywords. The keywords may be as broad as possible, but may all be related to the object in question.

In some embodiments, the inserted media content 25 could be identified by selecting the currently most popular keywords and making use of the engines (e.g. Bayesian or otherwise) to select particular media content 25 from the library.

### Displaying Advertising Related to Video Program Content

According to some embodiments, an advertising subsystem may be used for presenting advertisements or other information related to people, products, places, services or other elements (collectively henceforth referred to as “program elements”) contained in associated media content 25 on the device 14.

The advertising subsystem, in some instances implemented as one or more software applications (i.e. as part of the media player 12), may include a primary screen containing video thumbnails and short descriptors of program elements that were present in a particular video program. The primary screen may be displayed at various times. For example, the primary screen may be displayed automatically following the completion of the video program (a method known as “post-roll”). Alternatively, for example, the primary screen may be displayed at any predetermined time, or based on request of the user via a menu selection or other user interface (UI) action.

The “video thumbnails” may be similar to picture thumbnails in that they are a small graphical representation, but rather than a picture, the thumbnail may be a looping video clip depicting a specific occurrence of the program element as it appears in the associated video program.

When a user selects a particular video thumbnail or its descriptor, a number of actions may be taken, such as: presenting a larger version of the video thumbnail clip for better viewability; presenting a corresponding advertisement; presenting a survey or form to be completed by the user; presenting an interface through which the user may purchase the program element; and/or opening a web browser to a specified web page.

This system or method of displaying advertising may be superior to other advertising display methods for a number of different reasons. For example, the system may allow for many advertisements to be attached to a single video program (whereas pre-roll, mid-roll, and post-roll methods may be limited to only a few ads, as greater quantities of ads tend to increasingly delay or interrupt the viewing experience), and the system may allow users to view advertisements only for those products/services/places that they are interested in, resulting in higher user satisfaction.

Furthermore, advertisers may tend to get improved ad targeting, as such systems and methods tend to reduce the chances of an ad being shown to someone who isn't interested in the content of the ad. This tends to reduce costs for the advertiser as they typically pay advertising rates based on the number of times that an ad is displayed.

The video thumbnail tends to place the program element in the original context of the video program, which may better establish the relevance of the ad, and may improve viewer recall rates. For example, if the video program or media content 25 was a James Bond movie, then a video thumbnail could depict a particular character in the video (i.e. James Bond) driving an Aston Martin. The user may then be better able to recall the context in which the Aston Martin appeared in the film.

### Facilitating Offline Engagement of Interactive Internet Content

In many prior systems, Internet-based interactive content typically presumed that the user had a persistent connection to the Internet, and that data can be continually exchanged between the server and the user over the duration of the interaction.

In a mobile computing scenario, however, this presumption cannot be made. As discussed above, mobile Internet connections are often intermittent, resulting in users being unable to complete an interaction with particular interactive content. There are various web technologies that enable asynchronous or “offline” web applications to function, but these generally cannot be applied after the fact (i.e. they must be designed into the applications).

According to some embodiments, an offline advertising module (OAM) aims to “offline enable” websites and transaction systems without requiring any changes to the websites and transactions systems.

The OAM may include an application that runs on the mobile device 14, and which may be integrated with the media player 12. When the device 14 has an Internet connection (or other data connection), a website or web service may be downloaded. The depth of download into the site's “page tree” could be configurable, recognizing that depth and total size are generally proportional, and that the tree may branch exponentially.

The downloaded websites would then be hosted by the on-device application, and a browser or application may be directed to the on-device application when an Internet connection is not available (i.e. when the device 14 is in a reduced bandwidth communication state such as an “out of coverage” state or is offline). For example, if a transaction occurs while the device 14 is offline, the system 10 may subsequently contact the website when connectivity has been reestablished in order to complete the transaction, without typically requiring any further action from the user.

An exemplary embodiment of this application is to save the website content pertaining to a product being advertised within the media player 12. If the user clicks on an advertisement within the media player 12, and if the advertisement contained a link to a website, then the media player 12 could load the web page from the on-device application, rather than attempting to load it from the Internet. Loading the web page from the Internet may not possible in an out of coverage situation, but even when in coverage, there may be performance advantages to loading the site from the on-device server rather than from the Internet.

A further embodiment would be to save all or substantially all transaction information required to buy a product. For example, if the user wished to buy a product advertised within the media player 12, they could click on a “Buy Now” button. The transaction could be conducted between the user and the on-device application. When Internet connectivity is re-established, the transaction would be completed with a retailer's server, without generally requiring any further action from the user (or with reduced actions required). This frees the user from having to predicate their buying decision on whether or not the device 14 had an Internet connection.

### Quantifying Advertising Engagement on Interactive Rich Media Devices

A primary concern of advertisers is the degree to which consumers are “engaged” by an advertisement. Engagement encompasses a number of things such as: How much product/brand information was conveyed to the user?How much time did a user spend viewing an ad? How much interaction did the user undertake with ad?

Within in the media service provider 16, it may be possible to measure and report a wider range of engagement metrics than is currently common in the advertising industry. For example, the media service provider 16 may be configured such that a video advertisement presentation, as well as supplemental interactions with interactive advertising content, happen within the context of the media player 12 application.

This may allow for the measurement and reporting of metrics such as: How long did the user spend watching a particular video ad? Did they abandon the ad? If so, at what point? Did they watch the ad multiple times? Did the user elect to view supplemental web content associated with ad that was had pre-cached on the device? If so, how many pages were viewed? How much time was spent? How deep did they go into the site?

### Advanced Advertising Targeting

Another consideration for advertisers is ad targeting. Targeting is the ability to get a particular ad in front of a specific type of user. Advertisers have traditionally accomplished this by running ads in specific publications or on specific websites. For example, an automotive ad may be displayed in car magazines and websites. This type of targeting relies on demographic analysis, which ultimately is a generalization. Ads that rely too heavily on demographics tend to be displayed to some viewers that have little or no interest in the products offered by the advertiser, and similarly that the advertised have little or no interest in attracting.

In addition to demographic targeting, the media service provider 16 may offer targeting methods that are better able to focus in on the advertiser's target market, thus yielding higher response rates. For example, some media content 25 could be advertising content 44. Therefore, a relevance determination process can be applied to the advertising content 44 to determine whether particular advertising content 44 is relevant to a particular user. This provides for further targeted advertising opportunities.

In particular, the media service provider 16 may measure several things that enable superior advertising targeting, including for example user interests and on-going behavioral analysis.

### User Interests

Since users may have pre-configured sets of tags that characterize the type of video they wish to view, the media service provider 16 may generally determined that these tags reflect user interests. Accordingly, advertisements may be targeted to the users based on interests identified in the user's tags.

### On-Going Behavioral Analysis

Since the viewing experience tends to happen within the context of the media player 12 on one or more devices 14, user reaction to advertisements may be measured and tracked. This may allow the system 10 to present ads that the user is more interested in and receptive to, as defined by such metrics as:

Ad length: does the user's behaviour suggest preference for ads of a certain length? (i.e. do they skip longer ads?)

Ad type: does the user engage more with static video ads or with interactive ads?

Advertiser type: does the user engage more with certain types of advertisers than others (i.e. the user likes car ads but not financial services ads).

Displaying Ads within the UI of an Application

The media player 12 may be designed to allow advertisements to be dynamically inserted into the UI of the application or player 12. Examples of places where/when ads may be inserted could include: the center areas of the carousel 24 (e.g. between the rings 28a, 28b), or during non-use times such as when the user pauses a video, the ad may be overlaid, or replace the video, or the ad may be displayed immediately after particular media content, or after a period of time, such as for example, after a period of inactivity anywhere in the application or player 12.

### Optimistic Activation

When an account is created, the media service provider 16 may require the subscriber to validate their account and/or name/email address, typically by clicking on an embedded link in an email sent to that email address. The media service provider 16 may assume that the subscriber will eventually perform the activation and accordingly may start sending media content 25 to the device 14 generally immediately after account creation and before the activation is completed.

If, after a predetermined time period, the subscriber has not completed the activation, their account may be suspended. In some cases, all future requests may be redirected to an activation error notice, which may include a further notification being sent to the subscriber by email.

### Network Discovery and Reporting

In some embodiments, the media player 12 may monitor WiFi channel(s) for available WiFi or other data networks and may report any discovered networks (including, for example, identifier, location, . . . ) back to the media service provider 16. The network statistics may allow the media service provider 16 to identify networks near to the subscriber to be used as possible alternatives for data communication.

In some cases, network information can also be aggregated and supplied to networking partners as justification for signing up as a partner of the media service provider 16.

### Location Based Credentials Distribution

In some embodiments, the media service provider 16 can identify networks that are physically near the subscriber and may provide the location(s) thereof to the media player 12 application. The extra network information may enable the media player 12 to connect to the media service provider 16 with greater frequency and tend to keep the cache of media content 25 full.

In some examples, the media player 12 may make use of GPS information (or similar systems, where available) to locate networks.

### Predictive Networking

In some cases, based on the network location information, and the current location of the device 14, the media player 12 may predict the time until the next connection opportunity and use that information to ensure the cache generally always has enough new media content available. Network availability prediction may work in concert with the CQSS previously described above.

### Shared Credentials (Friends)

In some embodiments, subscribers of the media service provider 16 may have the option of supplying the media service provider 16 with credentials (i.e. SSID, password, etc.) for other networks the subscribers use or control (e.g. their home WiFi network).

Subscriber's may also choose to identify which of their “friends” are allowed to make use of those network credentials through the media service provider 16. Friends that are approved may automatically receive the credentials for these other networking sites. Once they have the credentials, they may no longer have to manually reconfigure their devices 14 to gain access to the WiFi local network.

### Social Recommendations

According to some embodiments, subscribers may on occasion recommend videos to their friends. In one form, the media player 12 may support the ability to submit a rating (public or private), a ranking, and/or comment to the media service provider 16. These recommendations may directly affect the queues of the subscriber's friends and may also be posted to the subscriber's social network, where they may be publicly available.

A subscriber can elect not to publicly share their opinions on their social networks. In such instances, their rating information may still be used to influence their own media queues and the media queues of their friends.

A subscriber may be allowed to select those friends in their social network that are allowed to influence their personal media queues. This may be desirable since social networks tend to have many friends, not all of which may share the tastes of the subscriber.

Subscribers could also potentially forward media content 25 (either the media content 25 itself, or a link to the media content 25 on the media service provider 16) to their friends. In the case where media content 25 is sent directly, the media service provider 16 may act as the gatekeeper allowing subscribers to share their current address(es) to enable direct communication.

Forwarding by sending a media link may immediately place that same item in the subscriber's friends queue(s). The subscriber's friends may then receive the media the next time their own media player 12 connects to the media service provider 16 to receive media content 25.

### Peer to Peer

As more and more devices that support ad-hoc networks become popular and generally available, it is conceivable that under some circumstances subscribers may wish to share media without using the media service provider 16. Potential reasons may include that no network is available, no “free” network is available (i.e. a network with $0 service charges, such as an open WiFi hotspot), or simply for speed, as in some instances it may be faster to share media directly between two devices 14 rather than going through the Internet 18 and the media service provider 16. In some embodiments, the media player 12 enables this behaviour by implementing a peer-to-peer (P2P) module.

When the subscribers want to initiate a direct transfer, enabling the P2P module may allow subscribers to establish connections via an available wireless network (WiFi, Bluetooth, infrared, etc.) to share files and communicate between devices 14.

The media player 12 P2P module may operate using a star topology, with the subscriber that wishes to share their media content acting as a virtual access point (e.g. the center node in the star).

A “P2P setup panel” may be created to provide a user interface to setup all parameters. This setup panel may include one or more options to be selected by the user. For example, the users may browse the available virtual access points through this window, with all available access points within the range being be displayed, and by clicking the corresponding icon, the user may be connected to that specified group.

Due to support limitations that may be present for particular hardware, in some cases each virtual access point may only host a limited number of users. Once that limitation is reached, a new virtual point must be created or the new user must wait until previous occupied resource is released before joining that access point.

Subscribers may be able to specify which parts of their media library they are willing to share, either by individual item, or by category, or in some cases this may be set by authorization criteria (e.g. users may not be permitted to share certain media content 25 due to copyright restrictions and the like). Users may also be able to use a messenger feature that allows the users to send and/or receive messages from other nodes in the same group. Subscribers may set up a password to limit access and/or block specified neighbours from access.

Sharing may also include social network details. If the subscriber has integrated their social network, then they may have the option of directly sharing those details with their friends. Those friends, when they receive the social network data, may have the choice of integrating/linking with those friends when next they contact the media service provider 16.

When there is no available access point around or the subscriber decides to create a new group, a new access point based on ad hoc networks may be created by this component. To avoid duplicate network identification information (e.g. “SSID”), the identification information of this virtual access point may be related to user's account (which is generally unique within a particular media service provider 16).

The P2P module of the media player 12 may allow the subscriber to assign a private IP address to the host node (i.e. the one who creates the virtual access point), By default, a predetermined IP address (e.g. 192.168.2.1), and sub mask (e.g. 255.255.255.0) may be used. Based on this, a DHCP module may dynamically assign the address to other nodes that require the connection.

At any time, the subscriber operating the host node may be free to drop connections in order to search out other groups.

While the above description provides examples of one or more systems, methods and apparatus, it will be appreciated that other systems, methods and apparatuses may be within the scope of the present description as interpreted by one of skill in the art.

1. A system for providing media content, comprising:
a) at least one media server;
b) at least one database connected to the at least one media server, each database configured to store a plurality of media content; and
c) at least one device configured for data communication with the at least one media server, each device associated with at least one user;
d) wherein each media server is configured to:
i) determine a relevance between each particular media content and each particular user, and
ii) based on each relevance, determine whether to provide that particular media content to the device associated with that particular user.

2. The system of claim 1, wherein each relevance is determined by a relevance engine and is based on metadata associated with the particular media content and the particular user.

3. The system of claim 1, wherein the metadata includes at least one of:
a) previously expressed interests by that particular user for other media content;
b) previously expressed interests of other users for other media content;
c) previously expressed interests of other users for that particular media content;
d) keywords associated with that particular media content;
e) keywords associated with that particular user; and
f) a relevance between that particular media content and other media content.

4. The system of claim 1, wherein the relevance is based on at least one classification algorithm.

5. The system of claim 4, wherein the classification algorithm includes a Bayesian filter.

6. The system of claim 3, wherein the previously expressed interests by that particular user includes ratings by that particular user of other media content indicative of that particular user's interest in a subject matter associated with the other media content.

7. The system of claim 3, wherein the previously expressed interest by that particular user includes rankings by that user of the other media content indicative of that particular user's perception of the quality of the other media content.

8. The system of claim 2, wherein the relevance engine is configured to create at least one cluster of users based on similarities in the media content consumed by those users.

9. The system of claim 8, wherein the relevance of particular media content to each user is determined at least in part by the membership of that particular user in the at least one cluster and relevance of that particular media content to that cluster.

10. The system of claim 1, wherein the media server is further configured to determine whether to provide particular media content to the device based on a personalized content quantity determination that estimates a quantity of media consumption for that device.

11. The system of claim 10 wherein the personalized content quantity determinations uses an access profile associated with the device that contains information about the media content consumption behavior for that device.

12. The system of claim 1, wherein at least one of the devices is a mobile communication device configured to operate in a high bandwidth communication state and a reduced bandwidth communication state, and wherein the media server is configured to provide the particular media content to the device when the device is in high bandwidth communication state but not when the device is in a reduced bandwidth communication state.

13. The system of claim 12, wherein determining whether to provide particular media content to the device is at least partially based on an estimate of how often the device is in a reduced bandwidth communication state.

14. The system of claim 12, wherein the reduced bandwidth communication state includes a non-communication state.

15. The system of claim 1, wherein the media server is configured to communicate with at least one social networking application, and wherein the media server determines whether to provide particular media content to the device based on data associated with the social networking application.

16. The system of claim 15, wherein the at least one social networking application include at least one of blogs, forums, websites, and other applications that permit community participation.

17. The system of claim 15, wherein the at least one social networking application is a media content source website configured to receive user engagement related to the media content provided on the website.

18. The system of claim 1 wherein the media content includes advertising content.

19. The system of claim 18, wherein the advertising content is interactive and permits the user to execute transactions relating to the advertising content.

20. The system of claim 19, wherein when at least one transaction is initiated while the device is in a reduced bandwidth communication state, information required to complete the transaction is temporarily stored, and then the information is subsequently used to complete the transaction when the device is in a high bandwidth communication state.

21. The system of claim 1, wherein each relevance is at least partially based on a prediction of a popularity of that particular media content.

22. A method for providing media content, comprising:
a) providing at least one media server;
b) providing at least one database connected to the at least one media server, each database configured to store a plurality of media content; and
c) providing at least one device configured for data communication with the at least one media server, each device associated with at least one user;
d) determining a relevance between each particular media content and each particular user;
e) based on each relevance, determining whether to provide that particular media content to the device associated with that particular user.

23. The method of claim 22, wherein each relevance is based on metadata associated with the particular media content and the particular user.

24. The method of claim 22, wherein the metadata includes at least one of:
a) previously expressed interests by that particular user for other media content;
b) previously expressed interests of other users for other media content;
c) previously expressed interests of other users for that particular media content; and
d) keywords associated with that particular media content;
e) keywords associated with that particular user; and
f) a relevance between that particular media content and other media content.

25. The method of claim 22, wherein the relevance is based on at least one classification algorithm.

26. The method of claim 25, wherein the classification algorithm includes a Bayesian filter.

27. The method of claim 24, wherein the previously expressed interest by that particular user includes ratings by that particular user of other media content indicative of that particular user's interest in a subject matter associated with the other media content.

28. The method of claim 24, wherein the previously expressed interest by that particular user includes rankings by that user of the other media content indicative of that particular user's perception of the quality of the other media content.

29. The method of claim 23, further comprising creating at least one cluster of users based on similarities in the media content consumed by those users.

30. The method of claim 29, wherein the relevance of particular media content to each user is determined at least in part by the membership of that particular user in the at least one cluster and relevance of that particular media content to that cluster.

31. The method of claim 22, further comprising determining whether to provide particular media content to the device based on a personalized content quantity determination that estimates a quantity of media consumption for that device.

32. The method of claim 31 wherein the personalized content quantity determinations uses an access profile associated with the device that contains information about the media content consumption behavior for that device.

33. The method of claim 22, wherein at least one of the devices is a mobile communication device configured to operate in a high bandwidth communication state and a reduced bandwidth communication state, and further comprising the step of providing the particular media content to the device when the device is in high bandwidth communication state but not when the device is in a reduced bandwidth communication state.

34. The method of claim 33, wherein determining whether to provide particular media content to the device is at least partially based on an estimate of how often the device is in a reduced bandwidth communication state.

35. The method of claim 33, wherein the reduced bandwidth communication state includes a non-communication state.

36. The method of claim 22, further comprising the steps of communicating with at least one social networking application, and determining whether to provide particular media content to the device based on data associated with the social networking application.

37. The method of claim 36, wherein the at least one social networking application include at least one of blogs, forums, websites, and other applications that permit community participation.

38. The method of claim 36, wherein the at least one social networking application is a media content source website configured to receive user engagement related to the media content provided on the website.

39. The method of claim 22 wherein the media content includes advertising content.

40. The method of claim 39, wherein the advertising content is interactive further comprising executing transactions relating to the advertising content.

41. The method of claim 40, further comprising the steps initiating at least one transaction while the device is in a reduced bandwidth communication state, storing information required to complete the transaction temporarily, and then subsequently completing the transaction using the information when the device is in a high bandwidth communication state.

42. The method of claim 22, wherein each relevance is at least partially based on a prediction of a popularity of that particular media content.

43. A physical computer readable medium including computer executable instructions which, when executed on a computing device, cause the computing device to:
a) determine a relevance between each particular media content of a plurality of media content and each particular user of a plurality of users; and
b) based on each relevance, determining whether to provide that particular media content to a device associated with that particular user.

44. The physical computer readable medium of claim 43, wherein each relevance is based on metadata associated with the particular media content and the particular user.

45. The physical computer readable medium of claim 44, wherein the metadata includes at least one of:
a) previously expressed interests by that particular user for other media content;
b) previously expressed interests of other users for other media content;
c) previously expressed interests of other users for that particular media content; and
d) keywords associated with that particular media content;
e) keywords associated with that particular user; and
f) a relevance between that particular media content and other media content.
